(19) United States
(12) Patent Application Publication
(10) Pub. No.: US 2006/0261560 A1
(43) Pub. Date: Nov. 23, 2006

(54) Sealing assemblies and methods for sealing an elongate member

(76) Inventors: David Ray Radliff, Holly Springs, NC (US); Gary W. Adams, Holly Springs, NC (US); Julian Mullaney, Raleigh, NC (US)

Correspondence Address: Marguerite E. Gerstner;Tyco Electronics Corporation, Intellectual Property Law Department, M/S R20/2B, 307 Constitution Drive, Menlo Park, CA, 94025-1164, US

(21) Appl. No.: 11/119,998

(22) Filed: May 2, 2005

(51) Int. Cl. F16J 15/00

(52) U.S. Cl. 277/345

(57) ABSTRACT

A sealing assembly for forming a seal about an elongate object includes a resilient seal member and a loading mechanism. The seal member includes an inner wall surface defining a channel to receive the elongate object. The inner wall surface includes at least one annular rib extending into the channel to engage the elongate object. The loading mechanism is adapted to selectively apply a compressive load to the seal member such that the inner wall surface is expanded inwardly to exert a sealing pressure on the elongate object.

### FIELD OF THE INVENTION

The present invention relates to sealing devices and, more particularly, to sealing devices for providing a seal between an opening in an object and an elongate article such as a cable.

### BACKGROUND OF THE INVENTION

It is often necessary to form a seal between an elongate object such as a cable and an opening in an object such as a pipe or splice enclosure. For example, in a telecommunications infrastructure, electrical connectors or splices may be housed in enclosures to protect them from harsh environments. It may be necessary or desirable to seal the enclosure against the ingress of water or the like. In particular, the enclosure may be provided with a sealing device to form a seal about each cable or wire at its entry into the enclosure.

### SUMMARY OF THE INVENTION

According to embodiments of the present invention, a sealing assembly for forming a seal about an elongate object includes a resilient seal member and a loading mechanism. The seal member includes an inner wall surface defining a channel to receive the elongate object. The inner wall surface includes at least one annular rib extending into the channel to engage the elongate object. The loading mechanism is adapted to selectively apply a compressive load to the seal member such that the inner wall surface is expanded inwardly to exert a sealing pressure on the elongate object.

According to further embodiments of the present invention, an enclosure assembly for use with an elongate object includes a housing and a sealing assembly for forming a seal about an elongate object. The sealing assembly includes a resilient seal member and a loading mechanism. The seal member includes an inner wall surface defining a channel to receive the elongate object. The inner wall surface includes at least one annular rib extending into the channel to engage the elongate object. The loading mechanism is adapted to selectively apply a compressive load to the seal member such that the inner wall surface is expanded inwardly to exert a sealing pressure on the elongate object. The housing member is mountable on the sealing assembly to form an enclosed chamber.

According to further embodiments of the present invention, a method for forming a seal about an elongate object includes inserting the elongate object into a channel of a resilient seal member, the seal member including an inner wall surface defining the channel and including at least one annular rib extending into the channel; and selectively applying a compressive load to the seal member such that the inner wall surface is expanded inwardly to exert a sealing pressure on the elongate object.

According to further embodiments of the present invention, a sealing assembly for forming a seal about an elongate object includes a resilient seal member and a loading mechanism. The seal member includes an inner wall surface defining a channel to receive the elongate object. The seal member is formed of a material having a durometer of no harder than about 30 Shore A. The loading mechanism is adapted to selectively apply a compressive load to the seal member such that the inner wall surface is expanded inwardly to exert a sealing pressure on the elongate object.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is an exploded, rear perspective view of an enclosure assembly according to embodiments of the present invention;

FIG. 2 is a fragmentary, front perspective view of the enclosure assembly of FIG. 1;

FIG. 3 is a front plan view of a seal member forming a part of the enclosure assembly of FIG. 1;

FIG. 4 is a cross-sectional view of the seal member of FIG. 3 taken along the line 4-4 of FIG. 3;

FIG. 5 is a rear, perspective view of a pressure member forming a part of the enclosure assembly of FIG. 1;

FIG. 6 is a fragmentary, cross-sectional view of the enclosure assembly of FIG. 1 taken along the line 6-6 of FIG. 2;

FIG. 7 is a fragmentary, cross-sectional view of the enclosure assembly of FIG. 1 taken along the same line as FIG. 6 and wherein a cable is inserted through a sealing channel thereof;

FIG. 8 is a fragmentary, cross-sectional view of the enclosure assembly of FIG. 1 taken along the same line as FIGS. 6 and 7 and wherein a loading mechanism forming a part of the enclosure assembly has been adjusted to compress the seal member about the cable;

FIG. 9 is a fragmentary, cross-sectional view of an enclosure assembly according to further embodiments of the present invention; and

FIG. 10 is a rear, perspective view of a sealing assembly according to further embodiments of the present invention.

FIG. 11 is an exploded, perspective view of a sealing assembly according to further embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

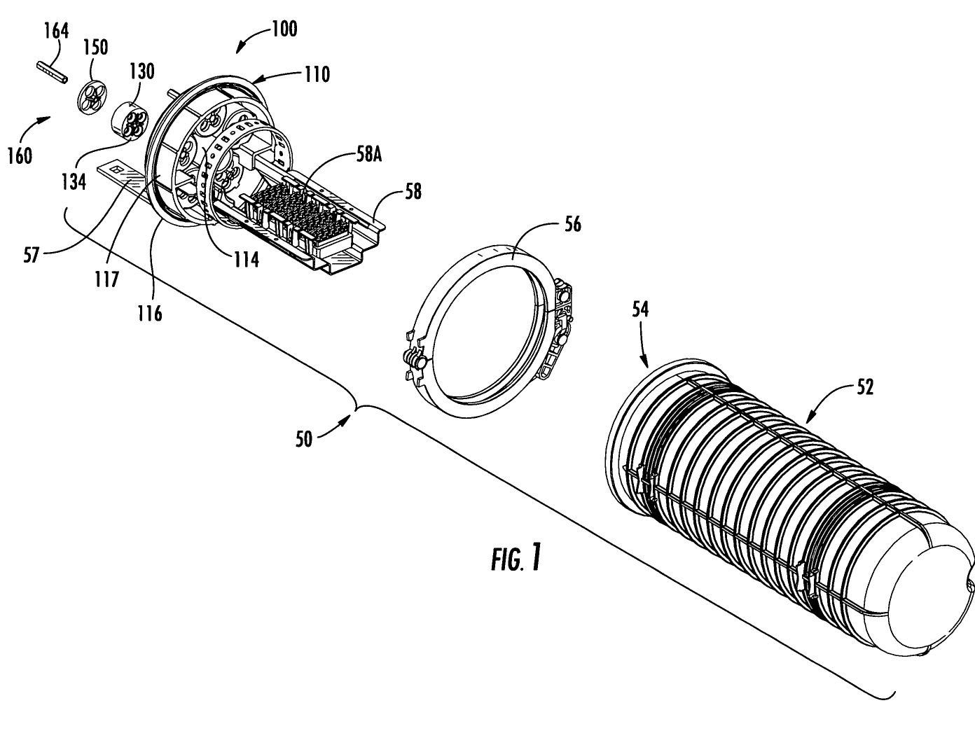

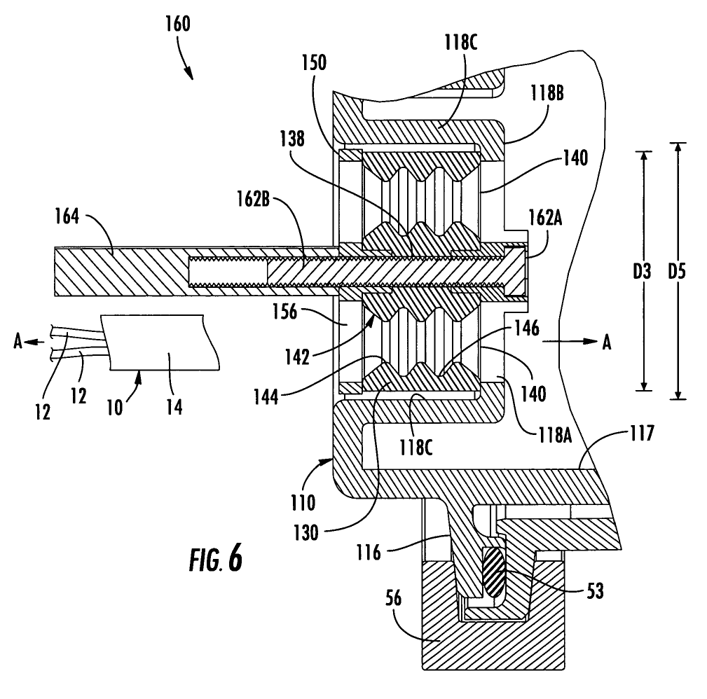

With reference to FIGS. 1-8, a sealing assembly 100 according to embodiments of the present invention is shown therein. The sealing assembly 100 may form a part of an enclosure assembly 50 to form a seal or seals between one or more elongate objects, such as a cable 10 (FIG. 6), and the enclosure assembly 50. As discussed in more detail below, the sealing assembly 100 may serve to provide a consistent, reliable and effective seal against ingress of water and other contaminants into the enclosure assembly 50. Moreover, the sealing assembly 100 may be adapted to accept and effectively seal about an expanded range of sizes of cables 10, and may be customizable to fit a variety of cable sizes.

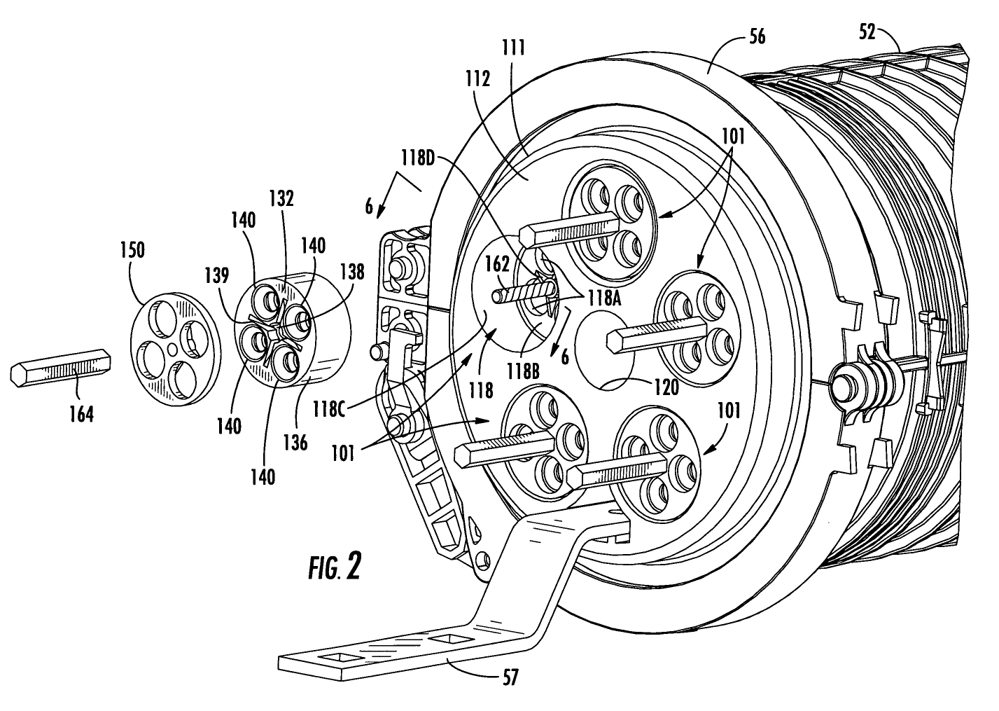

The sealing assembly 100 includes a base member 110, a plurality of resilient seal members 130, and a plurality of loading mechanisms 160. The base member 110, the seal members 130 and the loading mechanisms 160 form five sealing subassemblies 101 (FIG. 2).

With reference to FIGS. 1 and 2, the base member 110 includes a body 111 having a front side 112 (FIG. 2) and a rear side 114 (FIG. 1). Five cavities 118 (FIG. 2) are defined in the front side 112 and each forms a part of a respective one of the sealing subassemblies 101. Each cavity 118 is defined by a bottom wall 118B and a cylindrical side wall 118C. Four openings 118A are formed in each bottom wall 118B. A further opening 120 is also defined in the body 111. An X-shaped rib 118D is formed on the bottom wall 118B. An annular flange 116 (FIG. 1) extends radially outwardly from the body 111 and an annular flange 117 (FIG. 1) extends forwardly from the body 111.

The base member 110 may be formed of any suitable material. According to some embodiments, the base member 110 is a molded polymeric material. Suitable polymeric materials include polyolefins (e.g., polyethylene, polypropylene and copolymers thereof), acrylonitrile butadiene styrene copolymers (ABS), polybutylene terephthalate, nylon, polycarbonate, polyvinyl chloride and alloys or combinations of the aforementioned polymers or similar engineering polymers.

With reference to FIGS. 1-4, a respective seal member 130 is positioned in each cavity 118. The seal members 130 are formed of a resilient, pliable, deformable material. According to some embodiments, the seal members 130 are formed of a polymeric material. According to some embodiments, the seal members 130 are formed of an elastomeric material. According to some embodiments, the seal members 130 are formed of a rubber material. According to some embodiments, the seal members 130 are formed of silicone rubber. Other suitable materials may include polyurethane, chlorinated rubber, natural rubber, thermoplastic vulcanates (TPVs) nitrile rubber, ethylene propylene diene terpolymers (EPDM), silicone modified EPDM, fluoroelastomers, polyvinyl chloride, thermoplastic elastomers (e.g., polyolefins, polyesters or others), styrenic block copolymers and ethylene acrylic elastomers. The material of the seal members 130 may be self-lubricating.

According to some embodiments, the material of the seal members 130 has a durometer no harder than 70 Shore A. According to some embodiments, the seal members 130 are formed of material having a durometer no harder than 30 Shore A. According to some embodiments, the durometer is between about 30 and 10 Shore A. According to some embodiments, the durometer is between about 25 and 15 Shore A.

The seal members 130 may be of unitary construction as illustrated. As illustrated, the seal members 130 are substantially identical and one will be described hereinafter, it being appreciated that the description that follows applies equally to the remaining seal members 130. However, according to further embodiments, the seal members 130 may differ from one another in material and/or configuration.

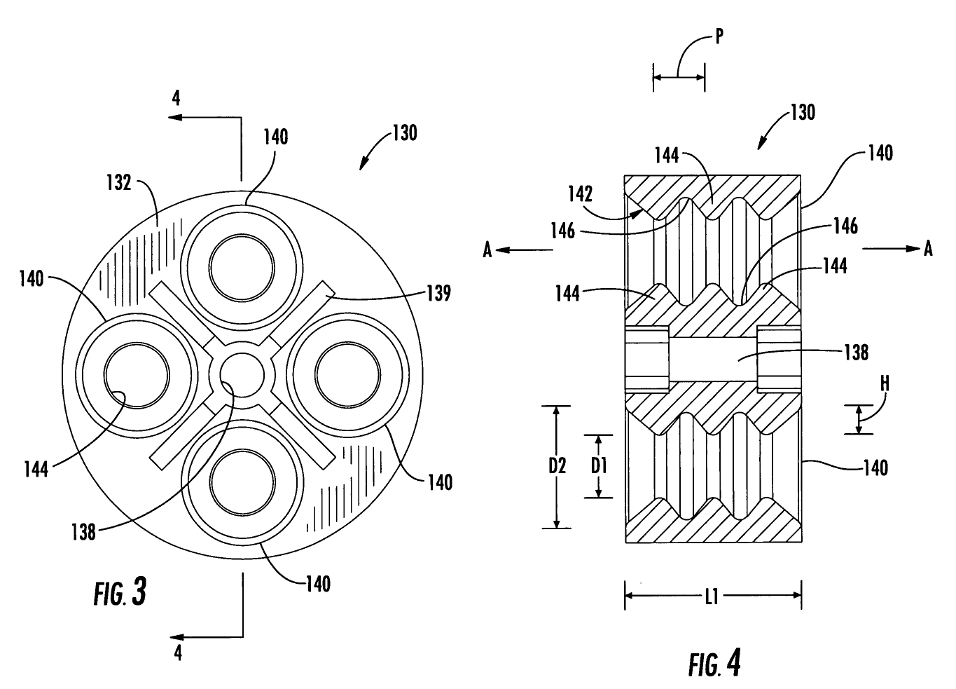

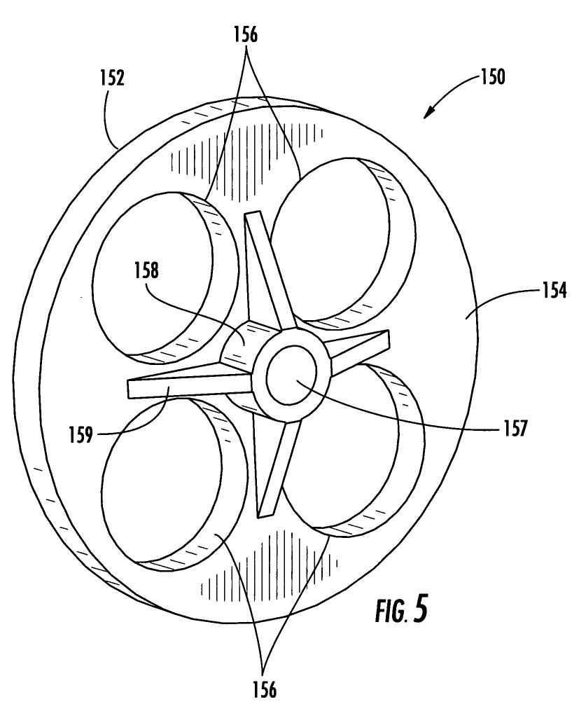

Referring now to FIGS. 3 and 4, the seal member 130 has a first side 132, an opposing rear side 134, and a cylindrical outer surface 136. Four spaced apart passages or channels 140 extend axially through the seal member 130 along a longitudinal axis A-A from the front side 132 to the rear side 134 and are defined by respective inner wall surfaces 142. A central hole 138 also extends axially through the seal member 130 and has countersinks 138A on either end. The channels 140 and the central hole 138 are laterally spaced apart. X-shaped grooves 139 are defined in the front surface 132 and in the rear surface 134. The X-shaped groove 139 on the rear side 134 receives the X-shaped rib 118D and the channels 140 align with respective ones of the openings 118A.

The outer diameter D3 (FIG. 6) of the seal member 130 is less than the inner diameter D5 (FIG. 6) of the corresponding cavity 118. According to some embodiments, the outer diameter D3 is between about 0.10 and 0.14 inch less than the inner diameter D5.

The channels 140 may be substantially identical or different. Referring to FIG. 4, each inner wall surface 142 includes a plurality of annular baffles or ribs 144 and a plurality of annular voids or troughs 146 alternatingly and serially arranged along the longitudinal axis A-A of the channel 140. Thus, as shown in FIG. 4, the inner wall surface 142 presents an undulating surface when viewed in cross-sectional profile. According to some embodiments, the profile is generally sinusoidal. According to some embodiments, the ribs 144 and the troughs 146 are substantially mirror images of one another as illustrated.

According to some embodiments, the pitch P (FIG. 4) between the ribs 144 is at least about 0.15 inch. According to some embodiments, the pitch P is between about 0.15 and 0.30 inch.

According to some embodiments, the depth H (FIG. 4) of each trough 146 (which is also the height of each rib 144) is at least about 0.05 inch. According to some embodiments, the depth H is between about 0.05 inch and 0.15 inch.

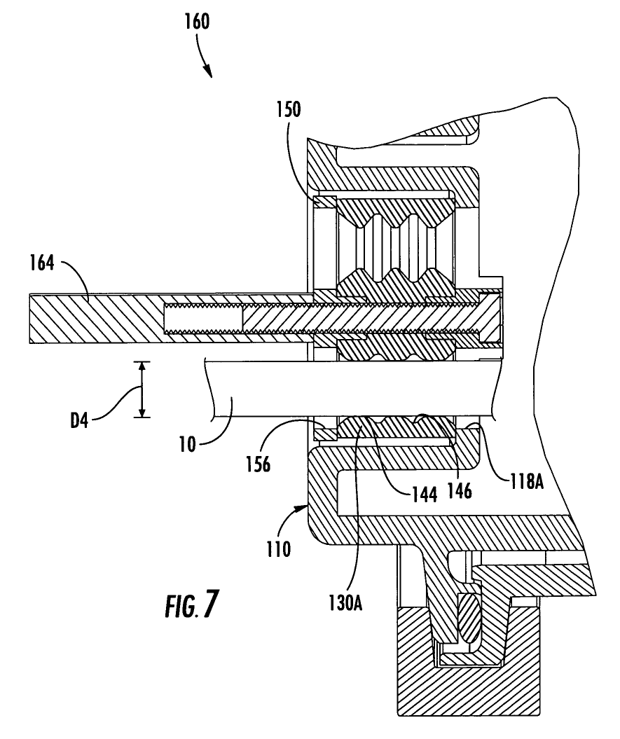

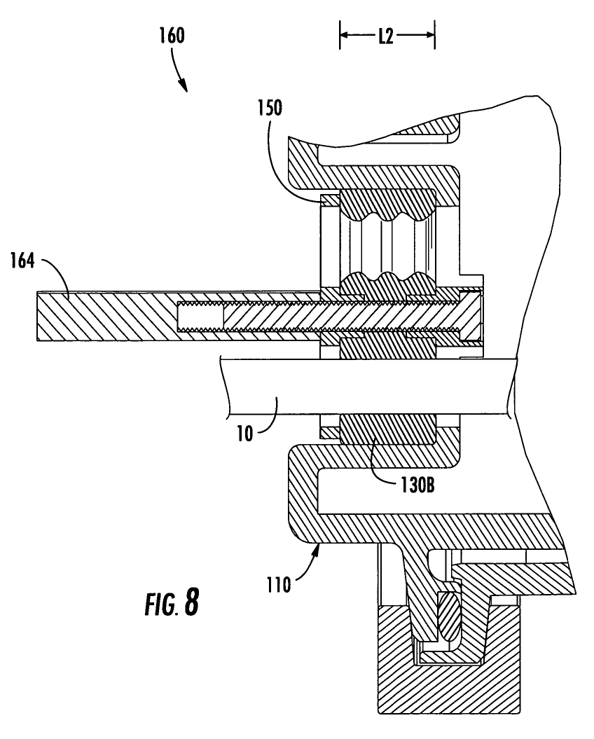

According to some embodiments, the inner diameter D1 (FIG. 4) of each rib 144 is at least about 0.25 inch. According to some embodiments, the diameter D1 of each rib 144 is between about 0.25 and 0.285 inch. According to some embodiments, the diameter D1 of each rib 144 is less than the diameter D4 (FIG. 7) of the smallest cable (or other elongate object) in the prescribed range of cables for which the channel 130 is intended. In addition and in accordance with some embodiments, the diameter D2 (FIG. 4) of the trough 146 is larger than the diameter D4 of the largest cable (or other elongate object) in the prescribed range of cables. According to some embodiments, the diameter D1 is between about 0.010 and 0.020 inch smaller than the diameter D4 of the smallest cable and the diameter D2 is between about 0.03 and 0.05 inch larger than the diameter D4 of the largest cable.

According to some embodiments, the length L1 (FIG. 4) of each channel 140 is at least about 0.7 inch. According to some embodiments, the length L1 of each passage 140 is between about 0.7 and 1.5 inch.

Each of the sealing subassemblies 101 includes a loading mechanism 160 associated with the corresponding cavity 118 and seal member 130. Each loading mechanism 160 includes a pressure plate or member 150, a bolt 162 and a nut 164.

As shown in FIG. 6, the bolt 162 is mounted in the base member 110 such that a head 162A of the bolt 162 is fixedly embedded in the corresponding bottom wall 118B and a threaded shank 162B of the bolt 162 extends up into the cavity 118 and through and beyond the center passage 138 of the seal member 130. The bolt head 162A may be inserted with rotation restraint, press-fitted or insert molded, for example, into the base member 110.

The pressure member 150 (FIG. 5) has a front side 152 and a rear side 154. Spaced apart holes 156 and a center hole 157 extend axially through the pressure member 150. An annular flange 158 extends rearwardly from the rear side 154 and an X-shaped rib 159 extends rearwardly from the rear side 154. The pressure member 150 is mounted on the front side 132 of the seal member 130 such that the rear side 154 contacts the front side 132, the X-shaped rib 159 is received in the X-shaped groove 139, the flange 158 is received in the adjacent countersink 138, the openings 156 align with respective ones of the channels 140, and the shank 162B extends up through the center hole 157. The channels 140 and the openings 118A, 156 are thus axially aligned to provide respective cable entry ports.

The nut 164 is internally threaded and threadedly engages the shank 162B. The diameter of the nut 164 is oversized relative to the diameter of the hole 157 such that the nut 164 can abut and apply an axially compressive load to the front side 152 of the pressure member 150.

The bolt 162 and the nut 164 may be formed of any suitable material. According to some embodiments, the bolt 162 and the nut 164 are formed of a metal such as steel. The pressure member 150 may be formed of any suitable material. According to some embodiments, the pressure member 150 is formed of a rigid polymeric material. According to some embodiments, the pressure member 150 is formed of stainless steel, aluminum, polymeric materials or glass reinforced polymeric materials such as poly (oxymethylene), polyvinylchloride, polypropylene, nylon, or polybutylene terephthalate. The pressure member 150 may be formed of a molded material.

According to some embodiments, the diameters of the openings 118A and 156 are substantially the same as or larger than the diameter D2 (FIG. 4) of the troughs 146 of the corresponding channels 140.

With reference to FIGS. 1, 2 and 6, the enclosure assembly 50 may include an upper, domed-shaped housing 52 mountable on the base member 110 to define an internal chamber 54. A support 58 is mounted on the base member 110 and extends up into the chamber 54 when the enclosure assembly 50 is assembled. A bracket 57 extends through and forwardly from the base member 110 for mounting the enclosure assembly 50 on a utility box or the like and/or for connecting to electrical ground. A connector block 58A or the like may be mounted on the support 58 for splicing or grounding wires fed into the chamber 54 through the base member 110. The connector block 58A may include a wiring stub (not shown) that extends through the opening 120 and is sealed therewith by any suitable means. A clamp 56 is provided to secure the housing 52 to the base member 110. An O-ring 53 (FIG. 6) is provided between the housing 52 and the base member 110 (e.g., in a groove in the flange 116) to form a seal between the housing 52 and the base member 110.

As noted above, the enclosure assembly 50 and the sealing assembly 100 may be used with any suitable elongate object, and are particularly contemplated for use with cables such as the cable 10 illustrated (FIG. 6), which is merely exemplary. The cable 10 may be of any suitable type or configuration. For example, the cable 10 may include a plurality of conductors 12 in a jacket 14. The outer surface of the jacket 14 serves as the outer surface of the cable 10. The conductors 12 may be, for example, insulated copper twisted pair wires, optical fibers, a coaxial wire or wires, etc. Alternatively, the cable may be a single insulated or uninsulated wire. The cable 10 may be a communications or power transmission cable, for example. The cable 10 has a nominal diameter D4.

The enclosure assembly 50 may be used and assembled in the following manner. The enclosure assembly 50 may be mounted in a pressurized or non-pressurized cabinet, for example. Generally, one or more cables 10 are inserted through the base member 110 as discussed in more detail below. The inserted ends of the cables 10 are connected to a connector block or otherwise terminated or addressed, and the cover 52 is mounted on the base member 110. The clamp 56 is applied about the cover 52 to secure the cover 52 to the base member 110.

FIG. 6 shows a representative sealing member 100 prior to installation of a cable 10. The cable 10 is inserted along the axis A-A through a channel 140 of the seal member 130 of the sealing assembly 100, the aligned pressure member opening 156 and the aligned base member opening 118A as shown in FIG. 7. Because the diameter D4 of the cable 10 is greater than the diameter D1 of the ribs 144 and the seal member 130 is relatively soft and deformable, the cable 10 contacts the ribs 144 and elastically deforms the seal member 130 into a partly compressed seal member 130A. The ribs 144 are deformed to partially fill the adjacent troughs 146 and the outer diameter of the seal member 130 may be expanded. The cable contact and the seal member deformation may serve to form a sealing engagement or contact between the outer surface 14A of the cable 10 and to retain the cable 10 in place during the subsequent loading operation and/or insertion of additional cables (or other elongate objects) into the seal member 130.

According to some embodiments, the seal member 130 is not loaded by the loading mechanism 160 while the cable 10 is being inserted. Alternatively, the seal member 130 may be partially axially compressed by the loading mechanism 160 while the cable 10 is being inserted.

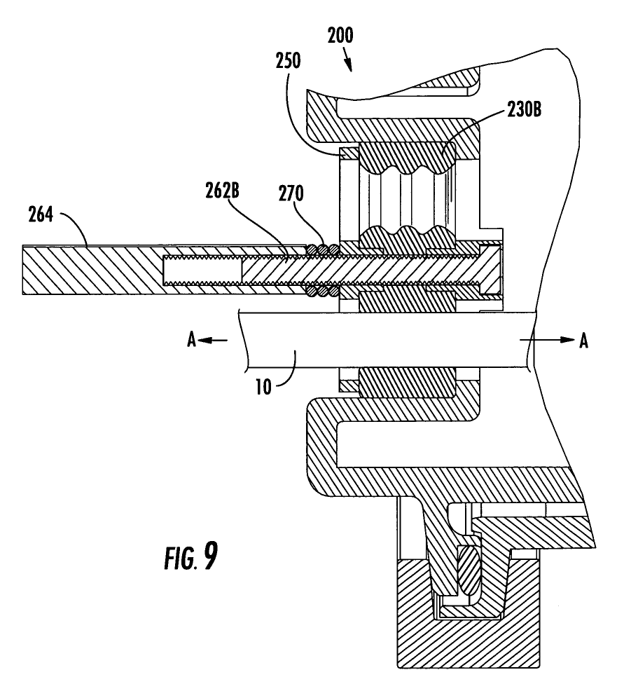

Once the cable 10 is in place, the user can rotate the nut 164 to axially displace or push the pressure member 150 toward the bottom wall 118B as shown in FIG. 8, thereby applying an axially compressive load to the seal member 130A which is interposed or sandwiched therebetween. In this manner, the seal member 130A is further deformed such that the outer surface 136 expands laterally or radially outwardly into sealing engagement with the side wall 118C and the inner surface 142 deforms inwardly to seal about outer surface of the cable 10, thereby forming a seal member 130B that is further axially compressed. In this manner, the sealing member 130 is axially compressed and laterally expanded to exert a sealing pressure around the cable 10. The total sealing pressure exerted may include the sealing pressure attributable to the oversized cable diameter (as discussed above) as well as the supplemental sealing pressure caused by the axial compression of the seal member 130. The amount of loading of the seal member 130 and thereby the cable 10 by the loading mechanism 160 can be selectively adjusted by operation of the nut 164. The engagements between the X-shaped ribs 118D, 159 and the grooves 139 may serve as a limiting or anchoring mechanism to prevent or inhibit rotation of the seal member 130 and the pressure member 150 relative to one another and the base member 110.

One or more additional cables 10 may be inserted through the other channels 140 of the seal member 130 before tightening the loading mechanism 160. When the nut 164 is rotated, each of the channels 140 will simultaneously contract to form a seal about the respective cable 10.

The channels 140 that are not used to receive cables may be plugged with plug rods, stoppers or the like, which may form seals with the seal member 130 in the same manner as with a cable. Additionally or alternatively, the seal member 130 may include an integral wall, skin, or other feature that extends across each channel 140 to seal the channel 140 until the wall, etc., is cut or pierced.

According to some embodiments, the loading mechanism 160 is adapted to provide a load on the seal member 130 of at least about 40 pounds. According to some embodiments, the loading mechanism 160 is adapted to provide a load of between about 40 and 80 pounds. According to some embodiments, the loading mechanism 160 is adapted to axially compress the seal member 130 to a length L2 (FIG. 8) that is less than 90% of the seal member's relaxed length L1 (FIG. 4) and, according to some embodiments, less than 60%.

The threaded arrangement of the bolt 162 and nut 164 may allow for a continuous range of adjustment of the compressive load within a prescribed range. A positive stop may be provided to limit the adjustment of the loading mechanism 160. For example, the shank 162B may be only partly threaded.

The sealing assembly 100 may provide a number of advantages. Because the seal member 130 can be subsequently compressed, the channels 140 can be formed of large enough diameter to allow for relatively easy insertion of the cables 10. Cable insertion may also be facilitated by the self-lubricating material of the seal member 130.

A good seal can be formed about each cable 10 and between the seal member 130 and the base member 110 for an extended range of cable sizes. The quality of the seal can be made substantially consistent without regard for the size of the cable (within the prescribed range). The loading mechanism 160 allows for the seal member 130 to be customized to fit the cable 10. It is not necessary to mount a bushing, spacer or the like on the cable 10 in order to properly fit the diameter of the cable to the channel 140. Cables of different sizes can be mounted in respective channels 140 of the seal member 130.

The security of the seal provided between the cable 10 and the seal member 130 can be augmented by the supplemental sealing pressure induced by the loading mechanism 160. Accordingly, an improved seal can be provided to withstand greater pressures (e.g., water level).

The pressure applied to the cable 10 can be selectively set so that a good seal is provided, but the cable 10 is not overloaded or overcompressed. Such overloading may damage the cable 10, particularly in the case of optical fibers.

Cables can be inserted, removed, and re-inserted (the same or a different cable) into the channels 140. The loading mechanism 160 can be loosened to facilitate removal and re-insertion. Once re-inserted, the loading mechanism can be used to form an improved seal about the cable as described above.

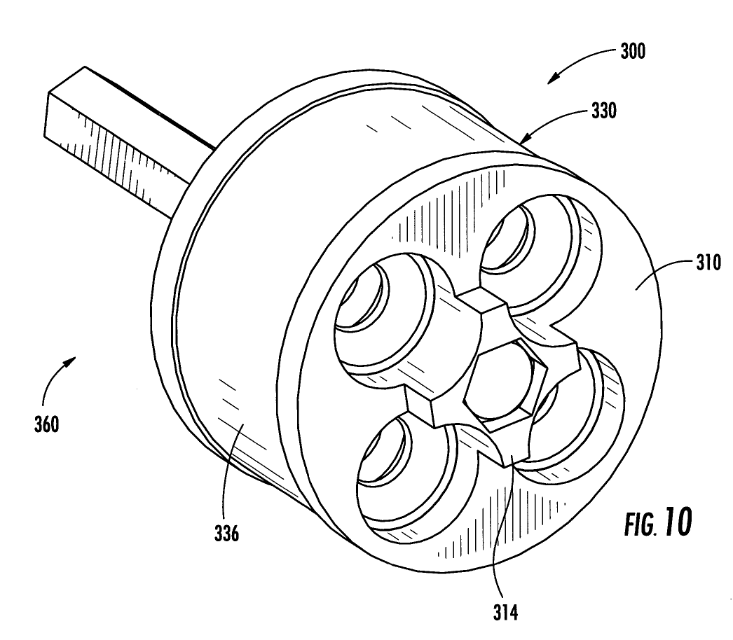

With reference to FIG. 9, a sealing assembly 200 according to further embodiments of the present invention is shown therein. The sealing assembly 200 differs from the sealing assembly 100 only in the further provision of a biasing member 270. The biasing member 270 may be a spring. According to some embodiments, the biasing member 270 is a coil spring mounted around the bolt shank 262B between the lower end of the nut 264 and the front side of the pressure member 250.

When the loading mechanism 260 of the sealing assembly 200 is in the compressing position as shown in FIG. 9, the biasing member 270 will continue to apply an axial load to the pressure member 250 and thereby to the seal member 230B. In this way, the biasing member 270 may serve to compensate for any relaxation, contraction, etc., in the sealing assembly 200 or the cable 10.

Other types of biasing members may be used. For example, the biasing member may include a Belleville washer, an elastomeric spring member, or a movable containment structure (e.g., a bladder) filled with a compressible gas.

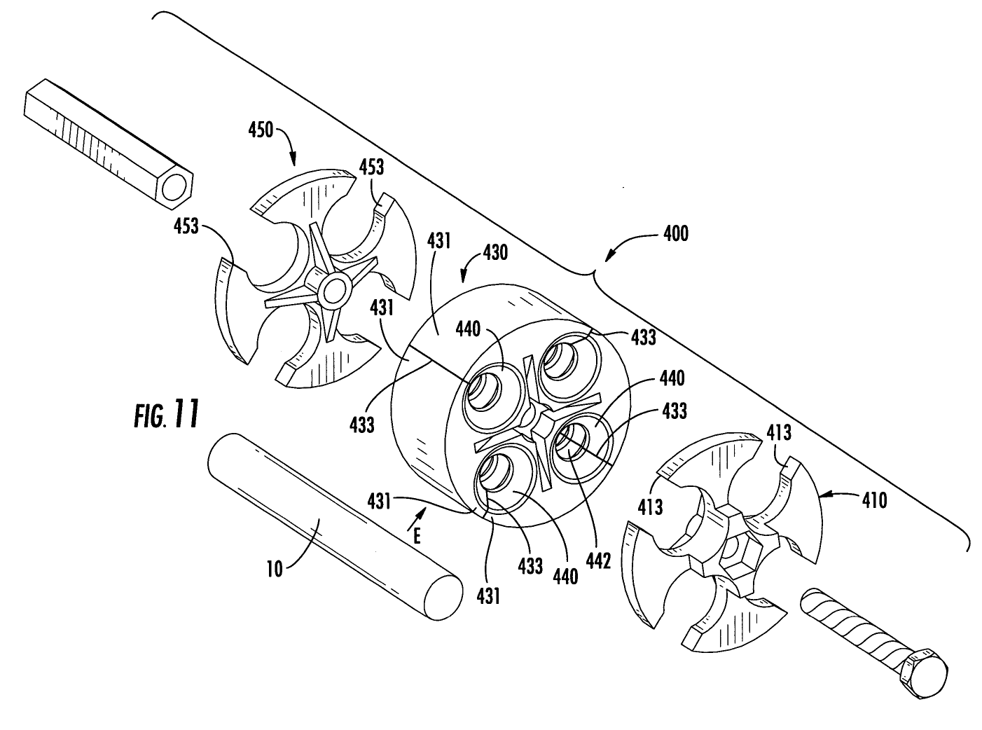

With reference to FIG. 10, a sealing assembly 300 according to further embodiments of the present invention is shown therein. The sealing assembly 300 differs from the sealing assembly 100 in that the base member 110 is replaced with a reduced base 310. The sealing assembly 300 may be placed in an opening of a duct (e.g., a tube), box or the like and used to seal about a cable or other elongate object as described above, and also to form a seal between the sealing assembly 300 and the opening of the structure. More particularly, as the loading mechanism 360 is operated to axially compress the seal member 330, the outer surface 336 of the seal member 330 will bulge radially or laterally outwardly to form a seal with the opening of the receiving structure. A head projection 314 is formed on the base 310 for engaging a tool.

With reference to FIG. 11, a sealing assembly 400 according to further embodiments of the present invention is shown therein in an exploded view. The sealing assembly 400 may be formed in the same manner as the sealing assembly 300 except that axially extending slits 433 are formed in the sealing member 430, radially opening side edge slots 413 are formed in the base member 410, and radially opening side edge slots 453 are formed in the pressure member 450. Each slit 433 extends radially through the seal member (including the inner wall surface 442) to the channel 440.

When the sealing assembly 400 is assembled, a cable 10 can be placed in a selected one of the channels 440 by pushing or inserting the cable 10 in a laterally or radially inward direction E as indicated in FIG. 11 through the chosen slit 433 and the associated slots 413, 453. The cable 10 is inserted laterally until the cable 10 seats in the channel 140 and the portions 431 on either side of the slit 433 close fully or partially about the cable 10. The insertion of the cable 10 in the channel 440 through the slit 433 can be facilitated by lifting one or both of the portions 431 out of the way to allow lateral insertion of the cable. Once the cable 10 is seated in the channel 440, the sealing assembly 430 can be compressed in the same manner as discussed above. The slits 433 and slots 413, 453 may be advantageously employed when it is not practicable or desirable to insert an end of the cable 10 axially through a channel 440.

While a cable 10 has been described above for the purposes of illustration, it will be appreciated that other elongate articles or objects may be sealed as well. For example, the sealing assemblies 100 may be used to form seals about mini tubes.

Various modifications may be made to the devices and methods described above. For example, the base member 110 may include more or fewer sealing subassemblies 101. Each sealing subassembly 101 may be provided with more or fewer passages to receive more or fewer cables or other elongate objects. The shapes of the passages 140 may be changed to complement cables or other elongate objects of other cross-sectional shapes (e.g., square, oval, etc.).

Other arrangements of threaded members may be employed to selectively displace the pressure member 150. For example, the bolt 162 may be replaced with an integrally and unitarily molded post. The bolt 162 may be replaced with a nut and the nut 164 with a threaded bolt. Other mechanisms, including non-threaded mechanisms, may be used to adjustably load the pressure member 150.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A sealing assembly for forming a seal about an elongate object, the sealing assembly comprising:
a resilient seal member including an inner wall surface defining a channel to receive the elongate object, the inner wall surface including at least one annular rib extending into the channel to engage the elongate object; and
a loading mechanism adapted to selectively apply a compressive load to the seal member such that the inner wall surface is expanded inwardly to exert a sealing pressure on the elongate object.

2. The sealing mechanism of claim 1 wherein the inner wall surface includes a plurality of annular ribs extending into the channel to engage the elongate object, the annular ribs being arranged in series along an axis of the channel and defining at least one trough therebetween.

3. The sealing assembly of claim 1 wherein:
the channel extends axially; and
the loading mechanism is adapted to selectively axially compress the seal member such that the inner wall surface is expanded radially inwardly.

4. The sealing assembly of claim 1 wherein the seal member is formed of an elastomeric material.

5. The sealing assembly of claim 4 wherein the seal member is formed of silicone rubber.

6. The sealing assembly of claim 1 wherein the seal member is formed of a material having a durometer of no harder than about 30 Shore A.

7. The sealing assembly of claim 6 wherein the seal member is formed of a material having a durometer of between about 30 and 10 Shore A.

8. The sealing assembly of claim 1 wherein:
the seal member includes a second inner wall surface defining a second channel to receive a second elongate object, the second inner wall surface including at least one second annular rib extending into the second channel to engage the second elongate object; and
when the loading mechanism applies the compressive load to the seal member, the second inner wall surface is expanded inwardly to exert a sealing pressure on the second elongate object.

9. The sealing assembly of claim 1 wherein the loading mechanism includes a pressure member that contacts the seal member and is displaceable to apply the compressive load to the seal member.

10. The sealing assembly of claim 9 wherein an opening is defined in the pressure member and is configured to receive the elongate object therethrough.

11. The sealing assembly of claim 9 wherein the loading mechanism further includes at least one threaded member that is rotatable to axially displace the pressure member to apply the compressive load to the seal member.

12. The sealing assembly of claim 11 wherein the at least one threaded member includes a nut and a threaded shank.

13. The sealing assembly of claim 9 including a base member, wherein the seal member is interposed between the pressure member and the base member such that, when the loading mechanism applies the compressive load to the seal member, the seal member is compressed between the pressure member and the base member.

14. The sealing assembly of claim 13 wherein:
the base member defines a cavity having a side wall; and
when the loading mechanism applies the compressive load to the seal member, an outer surface of the seal member expands outwardly to form a seal with the side wall of the base member.

15. The sealing assembly of claim 13 wherein the seal member includes an outer surface that is exposed between the pressure member and the base member and, when the loading mechanism applies the compressive load to the seal member, the outer surface of the seal member expands outwardly.

16. The sealing assembly of claim 1 including a biasing mechanism adapted to apply a compressive biasing load to the seal member.

17. The sealing assembly of claim 1 including a slit formed in the seal member and extending therethrough to permit lateral insertion of the elongate object into the channel.

18. The sealing assembly of claim 1 including an anchoring mechanism adapted to inhibit rotation of the seal member relative to the loading mechanism as the loading mechanism is adjusted to apply the compressive load to the seal member.

19. An enclosure assembly for use with an elongate object, the enclosure assembly comprising:
a) a sealing assembly for forming a seal about an elongate object, the sealing assembly including:
a resilient seal member including an inner wall surface defining a channel to receive the elongate object, the inner wall surface including at least one annular rib extending into the channel to engage the elongate object; and
a loading mechanism adapted to selectively apply a compressive load to the seal member such that the inner wall surface is expanded inwardly to exert a sealing pressure on the elongate object; and
b) a housing member mountable on the sealing assembly to form an enclosed chamber.

20. A method for forming a seal about an elongate object, the method comprising:
inserting the elongate object into a channel of a resilient seal member, the seal member including an inner wall surface defining the channel and including at least one annular rib extending into the channel; and
selectively applying a compressive load to the seal member such that the inner wall surface is expanded inwardly to exert a sealing pressure on the elongate object.

21. The method of claim 20 wherein inserting the elongate object into the channel of the seal member includes engaging the elongate object with the at least one annular rib such that the at least one annular rib is elastically deformed by the elongate object.

22. The method of claim 20 wherein the inner wall surface includes a plurality of annular ribs extending into the channel to engage the elongate object, the annular ribs being arranged in series along an axis of the channel and defining at least one trough therebetween.

23. The method of claim 20 wherein the seal member is formed of an elastomeric material.

24. The method of claim 23 wherein the seal member is formed of silicone rubber.

25. The method of claim 20 wherein the seal member is formed of a material having a durometer of no harder than about 30 Shore A.

26. The method of claim 20 including:
inserting a second elongate object into a second channel of the resilient seal member, the seal member including a second inner wall surface defining the second channel and including at least one second annular rib extending into the second channel; and
wherein selectively applying the compressive load to the seal member also expands the second inner wall surface inwardly to exert a sealing pressure on the second elongate object.

27. The method of claim 20 wherein selectively applying the compressive load to the seal member includes displacing a pressure member in contact with the seal member to apply the compressive load to the seal member.

28. The method of claim 20 including:
placing the seal member in an opening defined in a receiving object;
wherein selectively applying the compressive load to the seal member expands an exposed outer surface of the seal member outwardly to form a seal with the opening of the receiving object.

29. The method of claim 20 including applying a compressive spring biasing load to the seal member while the elongate object is disposed in the channel.

30. A sealing assembly for forming a seal about an elongate object, the sealing assembly comprising:
a resilient seal member including an inner wall surface defining a channel to receive the elongate object, wherein the seal member is formed of a material having a durometer of no harder than about 30 Shore A; and
a loading mechanism adapted to selectively apply a compressive load to the seal member such that the inner wall surface is expanded inwardly to exert a sealing pressure on the elongate object.

31. A sealing assembly for forming a seal about an elongate object, the sealing assembly comprising:
a resilient seal member including an inner wall surface defining a channel to receive the elongate object, wherein the seal member is formed of silicone rubber; and
a loading mechanism adapted to selectively apply a compressive load to the seal member such that the inner wall surface is expanded inwardly to exert a sealing pressure on the elongate object, the loading mechanism including a biasing mechanism adapted to apply a compressive biasing load to the seal member.

32. A sealing assembly for forming a seal about an elongate object, the sealing assembly comprising:
a resilient seal member including an inner wall surface defining a channel to receive the elongate object, wherein the seal member is formed of a material having a durometer of between about 30 and 10 Shore A; and
a loading mechanism adapted to selectively apply a compressive load to the seal member such that the inner wall surface is expanded inwardly to exert a sealing pressure on the elongate object, the loading mechanism including a biasing mechanism adapted to apply a compressive biasing load to the seal member.
